(19) United States
(12) Patent Application Publication
(10) Pub. No.: US 2018/0258819 A1
(43) Pub. Date: Sep. 13, 2018

(54) EXHAUST TURBINE POWER GENERATION SYSTEM

(71) Applicant: TOYOTA JIDOSHA KABUSHIKI KAISHA, Toyota-shi (JP)

(72) Inventor: Naruto YAMANE, Susono-shi (JP)

(73) Assignee: TOYOTA JIDOSHA KABUSHIKI KAISHA, Toyota-shi (JP)

(21) Appl. No.: 15/905,946

(22) Filed: Feb. 27, 2018

(30) Foreign Application Priority Data
Mar. 13, 2017 (JP) 2017-047086

(51) Int. Cl. F01N 5/04; F02M 26/14; F01N 13/08

(52) U.S. Cl. CPC F01N 5/04; F01N 13/08; F02M 26/14

(57) ABSTRACT

An exhaust turbine power generation system includes an internal combustion engine in which each cylinder includes an intake opening portion, a first exhaust opening portion, and a second exhaust opening portion; an exhaust turbine power generator in which a turbine is rotated by exhaust gas from the internal combustion engine to generate electric power; an intake pipe that is connected to the intake opening portion; a first exhaust pipe that connects the first exhaust opening portion to an inlet portion of the turbine; a second exhaust pipe that connects the second exhaust opening portion to a turbine-downstream exhaust pipe downstream of the turbine such that the second exhaust pipe bypasses the turbine; and an exhaust gas recirculation pipe that connects the second exhaust pipe to the intake pipe without being connected to the first exhaust pipe.

### INCORPORATION BY REFERENCE

The disclosure of Japanese Patent Application No. 2017-047086 filed on Mar. 13, 2017 including the specification, drawings and abstract is incorporated herein by reference in its entirety.

### BACKGROUND

### 1. Technical Field

The disclosure relates to an exhaust turbine power generation system that generates electric power using exhaust gas from an internal combustion engine.

### 2. Description of Related Art

Japanese Unexamined Patent Application Publication No. 2015-21448 (JP 2015-21448 A) discloses an exhaust turbine power generation system that generates electric power using exhaust energy of an internal combustion engine. In the exhaust turbine power generation system, an exhaust gas passage is divided into two channels. A first exhaust gas channel supplies exhaust gas in a blowdown flow to a turbine unit of an exhaust turbine power generator. An exhaust gas receiver that stores exhaust energy is provided in the first exhaust gas channel upstream of the turbine unit. A second exhaust gas channel causes exhaust gas in a scavenging flow to flow so as to bypass the exhaust gas receiver and the turbine unit.

Japanese Unexamined Patent Application Publication No. 2010-24972 (JP 2010-24972 A) discloses an internal combustion engine provided with a turbocharger.

The internal combustion engine includes a first exhaust gas passage that communicates with a turbine of a turbocharger, a second exhaust gas passage that does not communicate with the turbine, and an EGR passage that extends from an exhaust gas passage to an intake gas passage. The EGR passage includes a first EGR passage that is connected to the first exhaust gas passage upstream of the turbine and a second EGR passage that is connected to the second exhaust gas passage.

### SUMMARY

In an exhaust turbine power generation system, it is important to increase an expansion ratio of a turbine for increasing (enhancing) turbine work. Accordingly, it is necessary to increase a gas pressure at a turbine inlet. However, in the configuration disclosed in JP 2010-24972 A, the first EGR passage is connected to the first exhaust gas passage upstream of the turbine. In this case, part of the exhaust gas returns to an intake side via the first EGR passage, and a volume upstream of the turbine increases due to presence of the first EGR passage. Accordingly, a pressure of exhaust gas in the first exhaust gas passage is not likely to increase, that is, the gas pressure at the turbine inlet is not likely to increase. As a result, the turbine work decreases.

The disclosure provides a technique capable of enhancing turbine work in an exhaust turbine power generation system including two channels of exhaust paths.

An aspect of the disclosure provides an exhaust turbine power generation system. The exhaust turbine power generation system includes an internal combustion engine in which each cylinder includes an intake opening portion, a first exhaust opening portion, and a second exhaust opening portion; an exhaust turbine power generator in which a turbine is rotated by exhaust gas from the internal combustion engine to generate electric power; an intake pipe that is connected to the intake opening portion; a first exhaust pipe that connects the first exhaust opening portion to an inlet portion of the turbine; a second exhaust pipe that connects the second exhaust opening portion to a turbine-downstream exhaust pipe downstream of the turbine such that the second exhaust pipe bypasses the turbine; and an exhaust gas recirculation pipe that connects the second exhaust pipe to the intake pipe without being connected to the first exhaust pipe.

In the exhaust turbine power generation system according to the aspect, an exhaust gas path is divided into two channels. The first exhaust pipe is used to guide exhaust gas to the turbine of the exhaust turbine power generator. The second exhaust pipe is used to discharge exhaust gas such that the exhaust gas bypasses the turbine. The exhaust gas recirculation (EGR) pipe connects the second exhaust pipe to the intake pipe without being connected to the first exhaust pipe. Accordingly, it is possible to avoid a situation where part of exhaust gas in the first exhaust pipe is extracted as EGR gas. Thus, an amount of exhaust gas which is supplied to the turbine does not decrease. Further, an increase in volume upstream of the turbine does not occur. Accordingly, a gas pressure in the inlet portion of the turbine is likely to increase and the gas pressure increases by a large amount. That is, energy of the exhaust gas can be effectively introduced into the turbine to increase turbine input work. As a result, an expansion ratio of the turbine can be increased and the turbine work in the exhaust turbine power generation system can be enhanced.

In the aspect, a diameter of the second exhaust pipe may be larger than a diameter of the first exhaust pipe.

In the above-described configuration, the diameter of the second exhaust pipe is larger than the diameter of the first exhaust pipe. By decreasing the diameter of the first exhaust pipe, it is possible to reduce the volume of the first exhaust pipe and thus to further increase the turbine work. Since the diameter of the second exhaust pipe bypassing the turbine increases, a pipeline pressure loss decreases and a force required for pushing exhaust gas from a cylinder decreases. As a result, a pumping loss decreases. That is, it is possible to increase (enhance) turbine work and to reduce a pumping loss at the same time.

In the aspect, a plurality of the second exhaust pipes respectively connected to a plurality of the cylinders of the internal combustion engine may join at a junction; and the exhaust gas recirculation pipe may be connected to one of the plurality of the second exhaust pipes at a position upstream of the junction.

In the above-described configuration, the exhaust gas recirculation (EGR) pipe is connected to one of the plurality of the second exhaust pipes at the position upstream of the junction of the plurality of the second exhaust pipes. By connecting the EGR pipe to the position upstream of the junction, it is possible to shorten the EGR pipe.

By shortening the EGR pipe, it is possible to decrease a pressure loss and to appropriately introduce a desired amount of EGR gas to the intake pipe. That is, it is possible to improve EGR characteristics.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating an example of a configuration of an exhaust turbine power generation system according to a first embodiment of the disclosure;

FIG. 2 is a graph illustrating valve control in the exhaust turbine power generation system according to the first embodiment of the disclosure;

FIG. 3 is a graph illustrating how an exhaust gas pressure generally varies;

FIG. 4 is a graph illustrating dependency of turbine input work on an exhaust volume;

FIG. 5 is a diagram schematically illustrating features of an exhaust turbine power generation system according to a second embodiment of the disclosure; and

FIG. 6 is a diagram schematically illustrating an example of a configuration of an exhaust turbine power generation system according to a third embodiment of the disclosure.

### DETAILED DESCRIPTION OF EMBODIMENTS

Embodiments of the disclosure will be described below with reference to the accompanying drawings.

1. First embodiment 1-1. Basic configuration

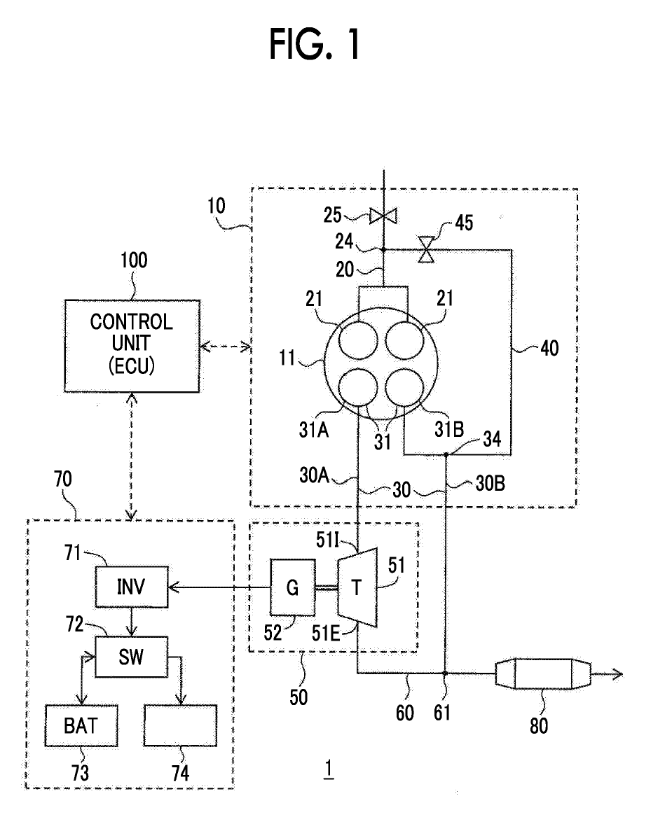

FIG. 1 is a diagram schematically illustrating an example of a configuration of an exhaust turbine power generation system 1 according to a first embodiment of the disclosure. The exhaust turbine power generation system 1 includes an internal combustion engine 10 (an engine), an exhaust turbine power generator 50, electrical equipment 70, and a control unit 100 as main components.

The internal combustion engine 10 includes a cylinder 11 (a combustion chamber) in which combustion is performed. Only one cylinder 11 is representatively illustrated in FIG. 1, but the number of cylinders 11 is not particularly limited. In the cylinder 11, a piston (not illustrated) is provided to reciprocate in an up-down direction. By causing the piston to move upward and downward, intake and exhaust are performed.

An intake pipe 20 (an intake port) is provided to supply intake gas into the cylinder 11. Opening portions of the intake pipe 20, which are open to the cylinder 11, are intake opening portions 21. That is, the intake pipe 20 is connected to the cylinder 11 at the intake opening portions 21. An intake valve (not illustrated) is provided in each intake opening portion 21 such that the intake valve opens and closes. By controlling opening and closing movements of the intake valve, supply of intake gas to the cylinder 11 is controlled. A throttle valve 25 that adjusts an amount of intake gas is provided in an intermediate part of the intake pipe 20.

An exhaust pipe 30 (an exhaust port) is provided to discharge exhaust gas from the cylinder 11. Opening portions of the exhaust pipe 30, which are open to the cylinder 11, are exhaust opening portions 31. That is, the exhaust pipe 30 is connected to the cylinder 11 at the exhaust opening portions 31. An exhaust valve (not illustrated) is provided in each exhaust opening portion 31 such that the exhaust valve opens and closes. By controlling opening and closing movements of the exhaust valve, discharge of exhaust gas from the cylinder 11 is controlled.

An exhaust gas recirculation (EGR) pipe 40 is provided to return part of exhaust gas as EGR gas to an intake side. For this purpose, the EGR pipe 40 is disposed to connect the exhaust pipe 30 to the intake pipe 20. A junction between the EGR pipe 40 and the intake pipe 20 is an EGR junction 24. The EGR junction 24 is located downstream of the throttle valve 25. A junction between the EGR pipe 40 and the exhaust pipe 30 is an EGR junction 34. Details of the EGR junction 34 will be described later. An EGR valve 45 that adjusts an amount of EGR gas is provided in an intermediate part of the EGR pipe 40.

The exhaust turbine power generator 50 is connected to a part of the exhaust pipe 30 and generates electric power using exhaust gas from the internal combustion engine 10. More specifically, the exhaust turbine power generator 50 includes a turbine 51 and a power generator 52 that is connected to an output shaft of the turbine 51. A gas inlet and a gas outlet of the turbine 51 are a turbine inlet portion 511 and a turbine outlet portion 51E, respectively. Exhaust gas from the internal combustion engine 10 is supplied to the turbine 51 via the turbine inlet portion 511, and thus, the turbine 51 is rotated by the supplied exhaust gas. When the turbine 51 is rotated, the power generator 52 is driven to generate electric power. In this way, the exhaust turbine power generator 50 converts exhaust energy from the internal combustion engine 10 into electric energy.

The turbine outlet portion 51E of the turbine 51 is connected to a turbine-downstream exhaust pipe 60 located downstream of the turbine 51. Exhaust having passed through the turbine 51 flows from the turbine outlet portion 51E to the turbine-downstream exhaust pipe 60. A catalyst 80 configured to clean exhaust gas is provided in an intermediate part of the turbine-downstream exhaust pipe 60.

The electrical equipment 70 uses electric power which is generated by the exhaust turbine power generator 50. More specifically, the electrical equipment 70 includes an inverter 71, a switch 72, a battery 73, and an electrical load 74. The electric power which is generated by the exhaust turbine power generator 50 is converted by the inverter 71 and is supplied to the battery 73 or the electrical load 74. Switching between supply of electric power to the battery 73 and supply of electric power to the electrical load 74 can be performed with the use of the switch 72. Further, by switching the switch 72, electric power discharged from the battery 73 can be supplied to the electrical load 74. For example, in a hybrid vehicle, the electrical load 74 includes a vehicle-driving motor (a motor for driving the vehicle).

The control unit 100 controls operations of the internal combustion engine 10 and the electrical equipment 70. Typically, the control unit 100 is a microcomputer including a processor, a storage device, and an input/output interface. The control unit 100 is also referred to as an electronic control unit (ECU). The control unit 100 controls the operation of the internal combustion engine 10 by controlling a degree of opening of the throttle valve 25, a degree of opening of the EGR valve 45, opening and closing times of each of the intake valve and the exhaust valve, injection of fuel, and so on. The control unit 100 controls charging and discharging of the battery 73 and supply of electric power to the electrical load 74 by controlling the inverter 71 and the switch 72.

### 1-2. Two Channels of Exhaust Gas Path

In the embodiment, the exhaust gas path is divided into two channels. More specifically, as illustrated in FIG. 1, the exhaust pipe 30 is divided into a first exhaust pipe 30A (a main exhaust pipe) and a second exhaust pipe 30B (a sub exhaust pipe). The first exhaust pipe 30A is connected to the cylinder 11 at a first exhaust opening portion 31A. The second exhaust pipe 30B is connected to the cylinder 11 at a second exhaust opening portion 31B. That is, the cylinder 11 includes the first exhaust opening portion 31A and the second exhaust opening portion 31B.

The first exhaust pipe 30A is used to guide exhaust gas to the turbine 51 of the exhaust turbine power generator 50. For this purpose, the first exhaust pipe 30A is disposed to connect the first exhaust opening portion 31A to the turbine inlet portion 51I.

The second exhaust pipe 30B is used to discharge exhaust gas such that the exhaust gas bypasses the turbine 51. For this purpose, the second exhaust pipe 30B is disposed to connect the second exhaust opening portion 31B to the turbine-downstream exhaust pipe 60 such that the second exhaust pipe 30B bypasses the turbine 51 (i.e., such that the second exhaust pipe 30B does not communicate with the turbine 51). That is, the second exhaust pipe 30B constitutes a bypass exhaust gas path bypassing the turbine 51. As illustrated in FIG. 1, the second exhaust pipe 30B is connected to the turbine-downstream exhaust pipe 60 at a bypass junction 61. The bypass junction 61 is located downstream of the turbine 51 and upstream of the catalyst 80.

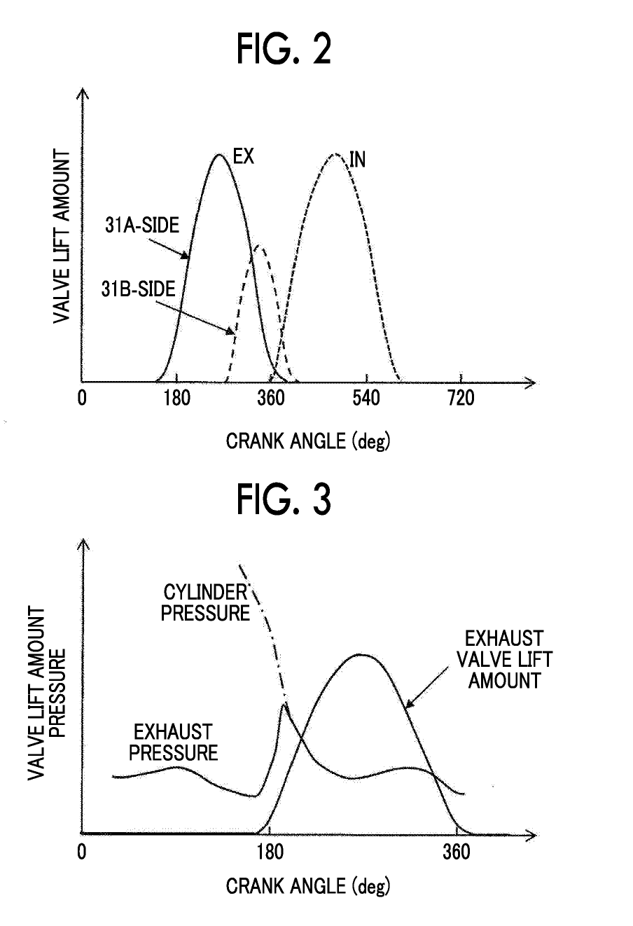

FIG. 2 is a graph illustrating valve control in the embodiment. The horizontal axis represents a crank angle, and the vertical axis represents lift amounts of valves. For explanation, an exhaust valve disposed in the first exhaust opening portion 31A is referred to as a “first exhaust valve” and an exhaust valve disposed in the second exhaust opening portion 31B is referred to as a “second exhaust valve.”

The first exhaust valve is opened and closed at normal times. That is, the first exhaust valve is opened in the vicinity of an exhaust bottom dead center and closed in the vicinity of an exhaust top dead center. Before the first exhaust valve is opened, the temperature and the pressure in the cylinder 11 increase in a combustion-expansion stroke of the internal combustion engine 10. Accordingly, immediately after the first exhaust valve is opened, high-temperature and high-pressure exhaust gas is discharged at a high speed that is close to the speed of sound. The exhaust gas flow in an initial stage of the exhaust stroke is referred to as a “blowdown flow.” Because the high-temperature and high-pressure blowdown flow is guided to the turbine 51 via the first exhaust pipe 30A, efficiency in driving the turbine 51 increases.

The opening and closing times of the second exhaust valve are after the opening and closing times of the first exhaust valve, respectively. Specifically, the second exhaust valve is opened in the vicinity of a time at which blowdown by the first exhaust valve ends, and is closed in the vicinity of the exhaust top dead center. A maximum lift amount of the second exhaust valve is smaller than a maximum lift amount of the first exhaust valve.

### 1-3. Enhancement of turbine Work

FIG. 3 is a graph illustrating how an exhaust pressure generally varies. The horizontal axis represents a crank angle and the vertical axis represents a pressure or a lift amount of the exhaust valve. Immediately after the valve lift of the exhaust valve starts, the valve lift amount is small and an opening area through which gas is discharged is small. A gas flow is limited to the speed of sound. Accordingly, immediately after the valve lift of the exhaust valve starts, an amount of exhaust gas flowing into the exhaust pipe is limited. Thereafter, as the valve lift amount increases, exhaust gas gradually flows out. Accordingly, as illustrated in FIG. 3, in an initial stage of the exhaust stroke, the exhaust pressure increases slowly. The tendency of the exhaust pressure to increase slowly becomes more marked (noticeable) as the volume of the exhaust pipe increases.

The same concept will be applied to the configuration according to the embodiment illustrated in FIG. 1. The lift amount of the exhaust valve illustrated in FIG. 3 corresponds to a lift amount of the first exhaust valve (see FIG. 2) in the first exhaust opening portion 31A (i.e., a lift amount on the first exhaust opening portion 31A-side) in the embodiment. Immediately after the valve lift of the first exhaust valve starts, an amount of exhaust gas flowing into the first exhaust pipe 30A is limited. At this time, when the volume of the first exhaust pipe 30A is large, the exhaust pressure in the first exhaust pipe 30A increases slowly. In this case, the gas pressure in the turbine inlet portion 51I of the turbine 51 also increases slowly.

In order to enhance the turbine work in the exhaust turbine power generation system 1, it is important to increase an expansion ratio of the turbine 51. For this purpose, it is necessary to increase the gas pressure in the turbine inlet portion 51I of the turbine 51. However, as described above, when the volume of the first exhaust pipe 30A is large, the exhaust pressure is not likely to increase in the initial stage of the exhaust stroke and the gas pressure in the turbine inlet portion 511 is not likely to increase.

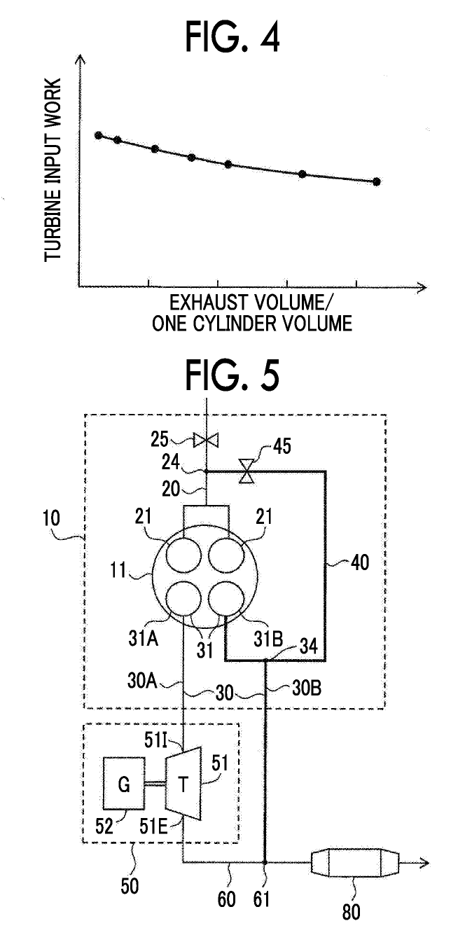

FIG. 4 is a graph illustrating dependency of the turbine input work on the exhaust volume. The horizontal axis represents an exhaust volume/one cylinder volume, and the vertical axis represents the turbine input work (work input to the turbine). Here, the exhaust volume is a volume of the first exhaust pipe 30A and is a volume from the first exhaust opening portion 31A to the turbine inlet portion 51I. One cylinder volume is the volume of one cylinder 11. FIG. 4 shows that the turbine input work decreases as the exhaust volume increases.

As described above, in order to effectively guide energy of exhaust gas to the turbine 51 and to enhance the turbine work, it is preferable that the volume of the first exhaust pipe 30A should be set to be as small as possible. The exhaust turbine power generation system 1 according to the embodiment is designed from this point of view.

Referring back to FIG. 1, in the embodiment, the EGR pipe 40 connects the second exhaust pipe 30B to the intake pipe 20 without being connected to the first exhaust pipe 30A. More specifically, the EGR pipe 40 connects the EGR junction 34 in the second exhaust pipe 30B and the EGR junction 24 in the intake pipe 20. No EGR pipe is connected to the first exhaust pipe 30A upstream of the turbine 51. That is, it is possible to avoid a situation where part of exhaust gas is extracted as EGR gas from the first exhaust pipe 30A upstream of the turbine 51.

A comparative example in which the EGR pipe 40 is connected to the first exhaust pipe 30A upstream of the turbine 51 will be considered. In this comparative example, part of exhaust gas is extracted as EGR gas from the first exhaust pipe 30A and is returned to the intake side via the EGR pipe 40. That is, an amount of exhaust gas which is input to the turbine 51 decreases. Connection of the EGR pipe 40 to the first exhaust pipe 30A is equivalent to an increase in volume of the first exhaust pipe 30A. From this point of view, the exhaust pressure is not likely to increase in the initial stage of the exhaust stroke and the gas pressure in the turbine inlet portion 51I is not likely to increase. As a result, the turbine work decreases.

In contrast, in the embodiment, no EGR pipe is connected to the first exhaust pipe 30A upstream of the turbine 51. Accordingly, no exhaust gas is extracted as EGR gas from the first exhaust pipe 30A, and thus, an amount of exhaust gas which is input to the turbine 51 does not decrease. An increase in volume upstream of the turbine 51 is not caused. Accordingly, the exhaust pressure in the turbine inlet portion 511 is likely to increase and the gas pressure increases by a large amount. That is, it is possible to effectively guide energy of exhaust gas (particularly, a blowdown flow in the initial stage of the exhaust stroke) to the turbine 51 and to increase the turbine input work (see

FIG. 4). As a result, the expansion ratio of the turbine 51 increases and the turbine work in the exhaust turbine power generation system 1 is enhanced.

### 2. Second Embodiment

FIG. 5 is a diagram schematically illustrating features of an exhaust turbine power generation system 1 according to a second embodiment of the disclosure.

In FIG. 5, the electrical equipment 70 and the control unit 100 are not illustrated. Description of the same components as those in the first embodiment will be omitted as appropriate.

In the embodiment, a diameter (a channel sectional area) of the second exhaust pipe 30B is larger than a diameter of the first exhaust pipe 30A. By decreasing the diameter of the first exhaust pipe 30A on the side of the turbine 51, it is possible to decrease the volume of the first exhaust pipe 30A and to further increase the turbine work. When the diameter of the second exhaust pipe 30B bypassing the turbine 51 increases, a pipeline pressure loss decreases and a force required for pushing exhaust gas from the cylinder 11 decreases. As a result, a pumping loss is reduced. That is, according to the embodiment, it is possible to increase (enhance) turbine work and to reduce a pumping loss at the same time.

### 3. Third Embodiment

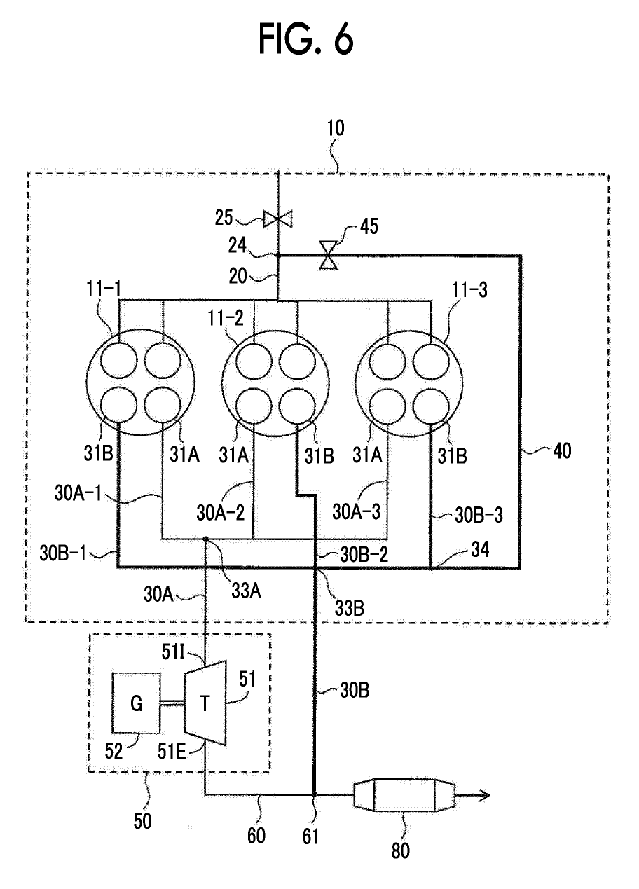

FIG. 6 is a diagram schematically illustrating an example of a configuration of an exhaust turbine power generation system 1 according to a third embodiment of the disclosure. In FIG. 6, the electrical equipment 70 and the control unit 100 are not illustrated. Description of the same components as those in the above-described embodiments will be omitted as appropriate.

In FIG. 6, a plurality of cylinders 11-i (where i=1 to 3) are illustrated. The first exhaust opening portion 31A and the second exhaust opening portion 31B of each cylinder 11-i are connected to the first exhaust pipe 30A-i and the second exhaust pipe 30B-i, respectively. A plurality of first exhaust pipes 30A-i extending from the cylinders 11-i (where i=1 to 3) join at a junction 33A and then extend to the turbine inlet portion 51I. A plurality of second exhaust pipes 30B-i extending from the cylinders 11-i (where i=1 to 3) join at a junction 33B and then extend to a bypass junction 61 in the turbine-downstream exhaust pipe 60.

In the embodiment, the EGR pipe 40 is connected to one of the second exhaust pipes 30B-i upstream of the junction 33B. In the example illustrated in FIG. 6, the EGR pipe 40 is connected to the second exhaust pipe 30B-3 at a position upstream of the junction 33B. By connecting the EGR pipe 40 to the position upstream of the junction 33B, it is possible to shorten the EGR pipe 40. By shortening the EGR pipe 40, it is possible to reduce a pressure loss and to appropriately introduce a desired amount of EGR gas into the intake pipe 20. That is, EGR characteristics are improved.

### 4. Fourth Embodiment

Parts of the first to third embodiments may be combined as long as they do not conflict with each other.

What is claimed is:

1. An exhaust turbine power generation system comprising:
an internal combustion engine in which each cylinder includes an intake opening portion, a first exhaust opening portion, and a second exhaust opening portion;
an exhaust turbine power generator in which a turbine is rotated by exhaust gas from the internal combustion engine to generate electric power;
an intake pipe that is connected to the intake opening portion;
a first exhaust pipe that connects the first exhaust opening portion to an inlet portion of the turbine;
a second exhaust pipe that connects the second exhaust opening portion to a turbine-downstream exhaust pipe downstream of the turbine such that the second exhaust pipe bypasses the turbine; and
an exhaust gas recirculation pipe that connects the second exhaust pipe to the intake pipe without being connected to the first exhaust pipe.

2. The exhaust turbine power generation system according to claim 1, wherein a diameter of the second exhaust pipe is larger than a diameter of the first exhaust pipe.

3. The exhaust turbine power generation system according to claim 1, wherein:
a plurality of the second exhaust pipes respectively connected to a plurality of the cylinders of the internal combustion engine join at a junction; and
the exhaust gas recirculation pipe is connected to one of the plurality of the second exhaust pipes at a position upstream of the junction.
